(19) United States
(12) Patent Application Publication
(10) Pub. No.: US 2007/0022095 A1
(43) Pub. Date: Jan. 25, 2007

(54) System and method for facilitating cross-compatibility of address books

(76) Inventors: Brenda F. Daos, Mission Viejo, CA (US); Vincent Wu, Irvine, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/186,069

(22) Filed: Jul. 21, 2005

(51) Int. Cl. G06F 17/30

(52) U.S. Cl. 707/3

(57) ABSTRACT

A system and method for enabling a cross-compatible address book for multiple document processing devices. First address data is first received in a first format and tested to determine the compatibility of the first address data relative to the second format. The first address data is then selectively converted, according to the output from the compatibility testing, into the second format. The converted address data is then stored in a common address book storage area. Next, the common address book is searched in response to a received address query. The result data communicatively output representing the result of the search of the common address book in response to the received address query.

### BACKGROUND OF THE INVENTION

This invention is directed to a system and method for address book management. More particularly, this invention is directed to a system and method for generating a cross-compatible address book for multiple document processing devices.

Current document processing devices include the ability to perform a variety of functions, including many types of data transmission operations, from electronic messaging to facsimile transmissions. These multifunction document processing devices include various address books, storing electronic mail addresses, telephone numbers, mailing addresses, phone numbers and the like. Unfortunately, each of the functions capable of being performed by the multifunction document processing devices require a different format for their respective address books. For example, the electronic mail functionality may use an address book in one format, while the facsimile function uses a second, incompatible format.

In addition, multiple document processing devices on a shared network typically do not use compatible address books. A user is required to perform several steps to facilitate the conversion of an address book in one format to the format required for the target device or function. Alternatively, the user is forced to manually enter the destination address due to the incompatibility of the address books.

There exists a need for a method and system for enabling the cross-compatibility of address books.

### SUMMARY OF THE INVENTION

In accordance with the present invention, there is provided a system and method for address book management.

Still further, in accordance with the present invention, there is provided a system and method for enabling the cross-compatibility of address books.

Still further, in accordance with the present invention, there is provided a cross-compatible address book for multiple document processing devices. Input means are used to receive first address data in a first format. Compatibility testing means are then employed to test the compatibility of the first address data relative to second format. Conversion means are then used to selectively convert, according to the output from the testing means, the first address data into the second format. The converted data is then stored in a common address book storage area. Search means are included, which facilitate the search of the common address book for address data in response to a received address query. Output means then communicate the resulting search data to the received address query.

Still further, in accordance with the present invention, there is provided a method for enabling a cross-compatible address book for multiple document processing devices. First address data is first received in a first format and tested to determine the compatibility of the first address data relative to the second format. The first address data is then selectively converted, according to the output from the compatibility testing, into the second format. The converted address data is then stored in a common address book storage area. Next, the common address book is searched in response to a received address query. The result data communicatively output representing the result of the search of the common address book in response to the received address query.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description, serve to explain the principles of the invention.

FIG. 1 is a block diagram illustrating a system in accordance with the present invention;

FIG. 2 is a flow chart illustrating an add address data to a common address book method in accordance with the present invention; and

FIG. 3 is a flow chart illustrating a request an address from a common address book method in accordance with the present invention.

### DETAILED DESCRIPTION OF THE PREFERRED EMBODIMENT

The present invention is directed to a system and method for document management. More particularly, the present invention is directed to an apparatus and method for managing and retrieving electronic documents on a document management system.

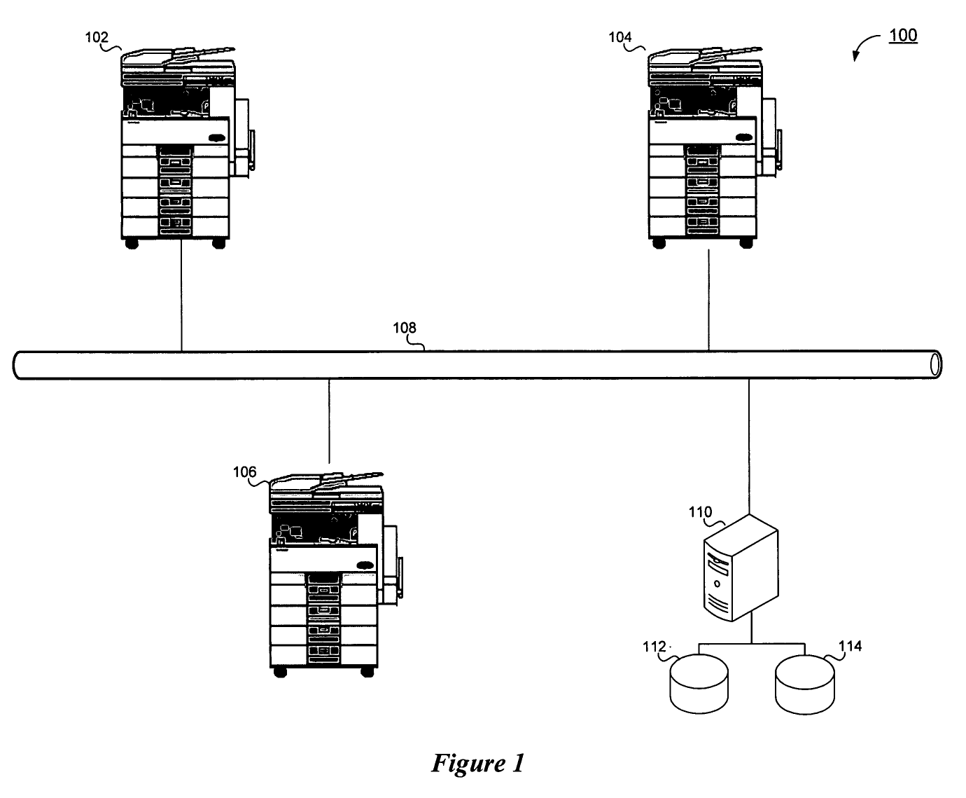

Turning now to FIG. 1, there is shown a diagram illustrating the system 100 in accordance with the present invention. As shown in FIG. 1, the system 100 suitably includes multiple document processing devices, designated as document processing devices 102, 104, and 106. It will be appreciated by those skilled in the art that the document processing devices 102-106 are any suitable document processing devices known in the art, such as a copier, printer, scanner, facsimile and the like, or any combination thereof. Suitable commercially available document processing peripherals include, but are not limited to, the Toshiba e-Studio Series Controller. Preferably, the document processing devices include a user-interface, suitably adapted to interact with a user. In one embodiment, the user-interface is a touch screen display capable of both displaying data and receiving input relating to the operations of the document processing devices 102-106.

Preferably, each of the document processing devices 102-106 are in data communication with a network 108 via any communications link known in the art. As will be understood by those skilled in the art, the communications link is any means for communication between electronic devices, including for example and without limitation, the Internet, a local area network, an Ethernet based connection, a wide area network, a Token Ring connection, a Bluetooth connection, a Wi-Fi connection, an IEEE802.11 connection, an infrared connection, a telephony connection, cellular connection and the like, or any combination of communications means thereof. The network 108 is any suitable computer network known in the art including, without limitation, a local area network, a wide area network, an intranet, and the Internet. More preferably, each of the document processing devices 102-106 are adapted to communicate with other devices (not shown) on the network 108 via any means known in the art. In the preferred embodiment, the computer network 108 is an Ethernet-based local area network. It will be understood by those skilled in the art that other forms of computer networks are equally capable of being employed by the present invention. It will further be appreciated by those skilled in the art that the document processing devices 102-106 are suitably located remotely from each other, communicating with each other via the network 108.

The system 100 further includes a server 110, communicatively coupled to the network 108. Preferably, the server 110 is in data communication with the document processing devices 102-106. It will be appreciated that the server 110 is suitably located independent from the devices 102-106, however, those skilled in the art will understand that the server 110 is equally capable of being integrated in one of the devices 102-106, without departing from the present invention. The server 110 preferably includes one or more data storage areas 112-114 suitably adapted to store data received via the computer network 108, including data received from the document processing devices 102-106. The storage areas 112-114 suitably correspond to one or more storage devices, capable of storing computer data. The storage devices are any data storage means known in the art, including, but not limited to, hard disk drive, flash memory drive, optical storage, magnetic storage and the like. More preferably, the server 110 facilitates the storage of a common address book on the storage area 112 in accordance with the present invention.

The skilled artisan will appreciate that each of the document processing devices 102-106 are capable of being different models of device, having different manufacturers, operating systems and the like. The present invention enables the cross-communication of the address data between each device 102-106. In accordance with the present invention, the document processing device 102 suitably processes address data in a first format specific to the device 102. The server 110 advantageously receives the address data from the device 102 and determines if the address data from the device 102 is compatible with the format designated by the server 110. When the address data is in a compatible, or alternatively, the same format as that designated by the server 110, the server 110 adds the address data to the common address book 112 stored thereon. When the address data received from the device 102 is not in a compatible format, the server 110 converts the address data to the designated format using any means known in the art. This converted address data is then added to the common address book 112 for other devices 104-106 to access.

Continuing with the preceding example, the document processing device 104 suitably processes address data in a third format, incompatible with the format of the other document processing devices 102 and 106. Accordingly, when address data is received from the device 104, the server 110 first determines whether the address data is in a compatible or the same format as the format designated by the server 110. When the format of the address data received from the device 104 is in a compatible or the same format, the address data is added to the common address book and thereby made accessible to the other devices 102 and 106 in the system 100. When it is determined that the document processing device 104 does process address data in the third format, the server 110 converts the data to the designated format using any means known in the art and stores the data in the common address book. It will be appreciated by those skilled in the art that the third document processing device 106, preferably processing address data in a fourth format, undergoes the same processes and techniques to add data to the common address book.

The preceding example is also capable of being performed in reverse such that any of the devices 102-106 is able to access the addresses stored in the common address book 112 of the server 110. Thus, when the document processing device 102 processes data in a first format that is incompatible with the designated format, the server 110 must first convert, using any means known in the art, the common address data in the second format to the first format understandable by the device 102. Once converted, the data is suitably transmitted to the device 102 from the server 110 via the network 108. Alternatively, when the server 110 is implemented integrally to the device 102, data is advantageously transmitted via associated bus or other internal data transfer channels.

It will be appreciated by those skilled in the art that the present invention suitably enables a user or administrator to add an address to the common address book 112 from either of the devices 102-106. For example, when an administrator adds an address to the common address book 112 via the user-interface of the device 102, the server 110 receives the address and determines whether the address is in a compatible format. When it is not in a compatible format, the address is converted from the format of the device 102 to the designated format and subsequently stored in the common address book.

It will further be understood by those skilled in the art that the retrieval of an address from the common address book 112 is suitably accomplished by any of the devices 102-106 in communication with the server 110. Thus, when a user or administrator instructs the completion of a document processing operation by the document processing device 106 that requires transmission of an output to one or more addresses, the device 106 submits a request to the server 110 for the appropriate address or addresses. The server 110 then determines the format required by the device 106 and whether the format is compatible with the designated format of the common address book 112 on the server 110. When the formats of the device 106 and the common address book 112 are the same or compatible, the requested device is suitably retrieved using any means known in the art and transmitted to the device 106 using the network 108. When the requested address is in an incompatible format, i.e, the device 106 requires a fourth format, which is different and incompatible the designated format of the server 110, the server 110 first automatically converts, via any means known in the art, the requested address data to the fourth format prior to transmission to the device 106.

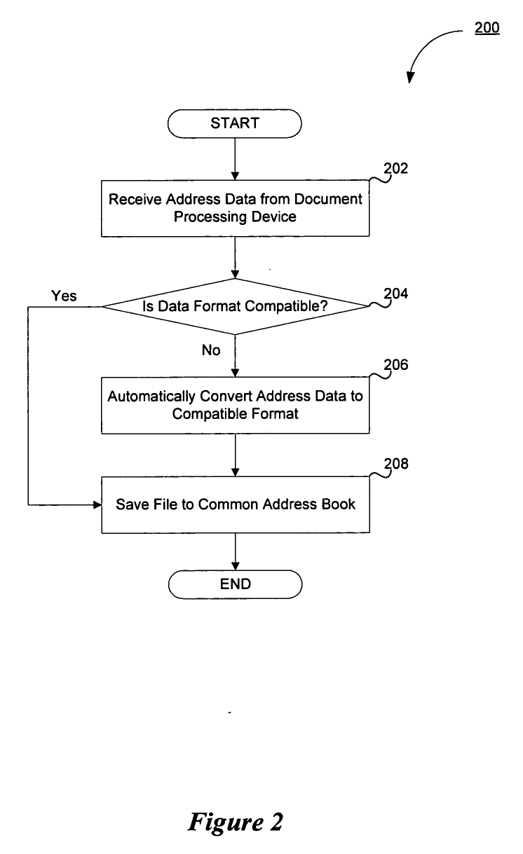

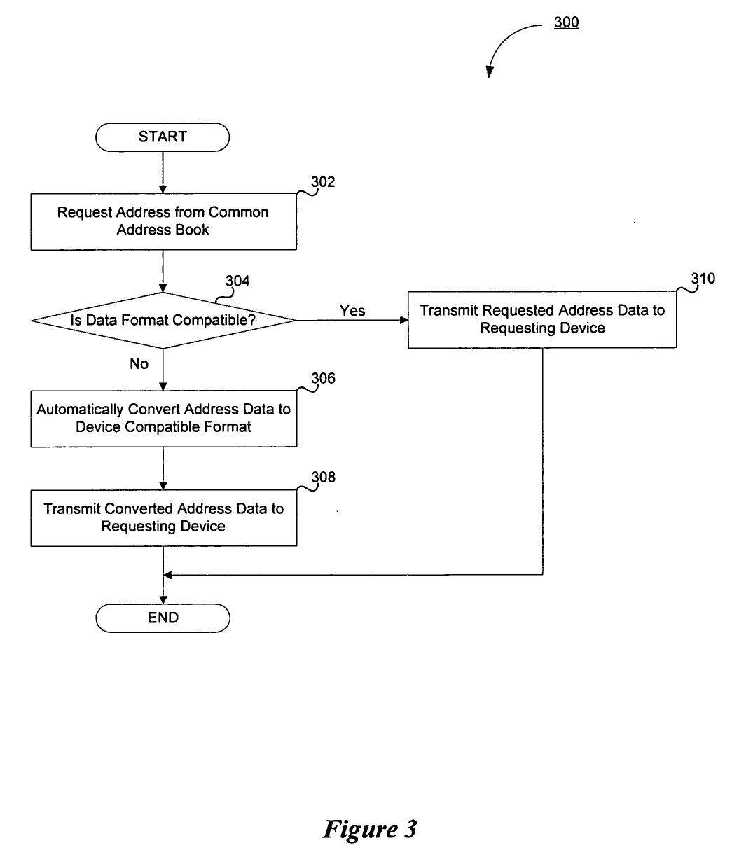

Operation of the present invention will better be understood in connection with the flow charts illustrated in FIGS. 2 and 3, discussed below. Turning now to FIG. 2, there is shown a flow chart 200 illustrating the method of adding address data to a common address book in accordance with the present invention. Beginning at step 202, the server 110 suitably receives address data from a document processing device via any means known in the art. For example, the document processing device 102 is added to the network 108, containing an internal address book, or listing of addresses. When added to the network 108, the device 102 suitably registers with the server 110 and provides the server 110 with the address data stored thereon. The server 110 then receives the address data in the device 102 format via any means known in the art. Alternatively, the device 104 has received a new address in device 104 format, input via a user interface, by a user or administrator, which is to be added to the common address book 112. The skilled artisan will appreciate that either preceding example will make use of the method described in FIG. 2. It will be understood by those skilled in the art that the address data received from the devices 102 and 104 is respectively in a format native to the device itself.

Once the address data is received by the server 110, which stores the common address book 112 in a second format, independent from the first and third formats of the devices 102 and 104, the server 110 determines at step 204 whether the data format received is compatible with the second format. For example, the server 110 analyzes the address data to determine if the address data received from the device 102 is in the second format or in a device 102 specific format. When it is determined that the address data received from the device 102 is not in the second format, the device 102 address data is automatically converted at step 206 to the second format using any means known in the art. For example, the device 102 address data is in a first format, which is not compatible with the second format of the common address book 112. The server 110 must first convert the address data from the first format to the second format before further processing will occur. Continuing with the preceding example, the device 104 address data is also analyzed to determine if the format of the address data is compatible with the designated format of the common address book 112. When the device 104 data format is in a third format, i.e., not compatible with the second format of the common address book 112, the server 110 automatically converts the device 104 address data from the third format to the second format using any means known in the art.

Once the address data has been converted to the second format, flow proceeds to step 208, wherein the converted address data is suitably stored in the common address book 112. When the device 102 address data is determined to be in a compatible format, that is, the device 102 native format is the second format employed by the common address book 112 of the server 110, the new address data is suitably stored in the common address book 112 as is known in the art. Similarly, when the device 104 format is determined to be the same as or compatible with the second format of the address book, the new address data is suitably stored in the common address book 112.

Referring now to FIG. 3, there is shown a flow chart 300 illustrating the retrieval of an address from the common address book 112 in accordance with the present invention. Beginning at step 302, the server 110 receives a request for an address from a device 106 via any means known in the art. At step 304, the server 110 determines whether the requesting device 106 address format is compatible with the format of the common address book 112. The skilled artisan will appreciate that the device 106 is capable of employing a device specific data format for processing addresses. Alternatively, the device 106 is capable of using a compatible data format, such as that used by the common address book 112, for processing addresses. When it is determined at step 304 that the data format of the common address book 112 and the format of the device 106 are not compatible, flow proceeds to step 306. At step 306, the server 110 automatically converts the requested address data, stored in the common address book 112, from the second format to the format specific to the requesting device 106, e.g., a fourth data format.

Once the requested address data has been converted by the server 110 from the second format to the fourth format, i.e., device 106 data format, the converted address data is transmitted to the requesting device 106 at step 308. Returning to step 304, a determination that the device 106 format is compatible with the data format of the common address book 112 progresses flow to step 310, wherein the requested address data is transmitted to the requesting device 106. As will be understood by those skilled in the art, the present invention is capable of importing multiple address books of any format into the common address book 112, exporting one or more addresses from the common address book 112 to a requesting device in any format required by such device, restoring a damaged or deleted device specific address book, archiving an address book for later usage, and the like. Preferably, when using the restore and/or archival features of the present invention, a non-editable sub-extension will be implemented to indicate the address data and device to which the address data is able to be restored. The skilled artisan will appreciate that upon when the address data has been stored in a format different than that which the original device uses, the address data is first converted, via any means known in the art, and restored following such conversion.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program, for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A cross-compatible address book for multiple document processing devices comprising:
input means adapted for receiving first address data in a first format;
compatibility testing means for testing compatibility of the first address data relative to a second format;
conversion means adapted for selectively converting, in accordance with an output of the compatibility testing means, address data in the first format to address data in the second format;
common address book storage adapted for storing converted address data in a common address book storage area;
search means adapted for searching the common address book for address data responsive to a received address query; and
output means adapted for communicating result data representative of a result of a search of the common address book responsive to the received address query.

2. The cross-compatible address book for multiple document processing devices of claim 1, wherein at least one of the input means and the output means are adapted for data communication via an associated data network.

3. The cross-compatible address book for multiple document processing devices of claim 2, wherein the common address book storage is disposed on a controller of an associated document processing device.

4. The cross-compatible address book for multiple document processing devices of claim 2, wherein the common address book is disposed on a memory of a networked workstation.

5. The cross-compatible address book for multiple document processing devices of claim 2, wherein:
the input means includes means for receiving third address data in a third format;
the compatibility means includes means for testing compatibility of the third address data relative to the second format; and
the conversion means includes means adapted for selectively converting, in accordance with an output of the compatibility testing means, address data in the format to address data in the second format.

6. The cross-compatible address book for multiple document processing devices of claim 5, wherein address data in the first format is native to a first document processing device and address data in the third format is native to second document processing device, and wherein the first format and third format are mutually incompatible.

7. The cross-compatible address book for multiple document processing devices of claim 6, wherein the first document processing device is at least one of the group consisting of a copy machine, a printer, a facsimile machine, a scanner, and a multifunction peripheral device, and wherein the second document processing device is at least one of the group consisting of a copy machine, a printer, a facsimile machine, a scanner, and a multifunction peripheral device.

8. A method for enabling a cross-compatible address book for multiple document processing devices comprising the steps of:
receiving first address data in a first format;
testing compatibility of the first address data relative to a second format;
selectively converting, in accordance with an output of the compatibility testing step, address data in the first format to address data in the second format;
storing converted address data in a common address book storage area;
searching the common address book for address data responsive to a received address query; and
communicating result data representative of a result of a search of the common address book responsive to the received address query.

9. The method for enabling a cross-compatible address book for multiple document processing devices of claim 8, wherein at least one of the first address data in the first format and the result data are communicated via an associated data network.

10. The method for enabling a cross-compatible address book for multiple document processing devices of claim 9, wherein the common address book storage is disposed on a controller of an associated document processing device.

11. The method for enabling a cross-compatible address book for multiple document processing devices of claim 9, wherein the common address book is disposed on a memory of a networked workstation.

12. The method for enabling a cross-compatible address book for multiple document processing devices of claim 9, further comprising the steps of:
receiving third address data in a third format;
testing compatibility of the third address data relative to the second format; and
selectively converting, in accordance with an output of the compatibility testing step, address data in the format to address data in the second format.

13. The method for enabling a cross-compatible address book for multiple document processing devices of claim 12, wherein address data in the first format is native to a first document processing device and address data in the third format is native to second document processing device, and wherein the first format and third format are mutually incompatible.

14. The method for enabling a cross-compatible address book for multiple document processing devices of claim 13, wherein the first document processing device is at least one of the group consisting of a copy machine, a printer, a facsimile machine, a scanner, and a multifunction peripheral device, and wherein the second document processing device is at least one of the group consisting of a copy machine, a printer, a facsimile machine, a scanner, and a multifunction peripheral device.

15. A computer-readable medium of instructions with computer-readable instructions stored thereon for enabling a cross-compatible address book for multiple document processing devices comprising:
instructions for receiving first address data in a first format;
instructions for testing compatibility of the first address data relative to a second format;
instructions for selectively converting, in accordance with an output of the compatibility testing, address data in the first format to address data in the second format;
instructions for storing converted address data in a common address book storage area;
instructions for searching the common address book for address data responsive to a received address query; and
instructions for communicating result data representative of a result of a search of the common address book responsive to the received address query.

16. The computer-readable medium of instructions with computer-readable instructions stored thereon for enabling a cross-compatible address book for multiple document processing devices of claim 15, wherein at least one of the first address data in the first format and the result data are communicated via an associated data network.

17. The computer-readable medium of instructions with computer-readable instructions stored thereon for enabling a cross-compatible address book for multiple document processing devices of claim 16, wherein the common address book storage is disposed on a controller of an associated document processing device.

18. The computer-readable medium of instructions with computer-readable instructions stored thereon for enabling a cross-compatible address book for multiple document processing devices of claim 16, wherein the common address book is disposed on a memory of a networked workstation.

19. The computer-readable medium of instructions with computer-readable instructions stored thereon for enabling a cross-compatible address book for multiple document processing devices of claim 16, further comprising:
instructions for receiving third address data in a third format;
instructions for testing compatibility of the third address data relative to the second format; and
instructions for selectively converting, in accordance with an output of the compatibility testing, address data in the format to address data in the second format.

20. The computer-readable medium of instructions with computer-readable instructions stored thereon for enabling a cross-compatible address book for multiple document processing devices of claim 19, wherein address data in the first format is native to a first document processing device and address data in the third format is native to second document processing device, and wherein the first format and third format are mutually incompatible.

21. The computer-readable medium of instructions with computer-readable instructions stored thereon for enabling a cross-compatible address book for multiple document processing devices of claim 20, wherein the first document processing device is at least one of the group consisting of a copy machine, a printer, a facsimile machine, a scanner, and a multifunction peripheral device, and wherein the second document processing device is at least one of the group consisting of a copy machine, a printer, a facsimile machine, a scanner, and a multifunction peripheral device.

22. A computer-implemented method for enabling a cross-compatible address book for multiple document processing devices comprising the steps of:
receiving first address data in a first format;
testing compatibility of the first address data relative to a second format;
selectively converting, in accordance with an output of the compatibility testing step, address data in the first format to address data in the second format;
storing converted address data in a common address book storage area;
searching the common address book for address data responsive to a received address query; and
communicating result data representative of a result of a search of the common address book responsive to the received address query.

23. The computer-implemented method for enabling a cross-compatible address book for multiple document processing devices of claim 22 wherein at least one of the first address data in the first format and the result data are communicated via an associated data network.

24. The computer-implemented method for enabling a cross-compatible address book for multiple document processing devices of claim 23, wherein the common address book storage is disposed on a controller of an associated document processing device.

25. The computer-implemented method for enabling a cross-compatible address book for multiple document processing devices of claim 23, wherein the common address book is disposed on a memory of a networked workstation.

26. The computer-implemented method for enabling a cross-compatible address book for multiple document processing devices of claim 23, further comprising the steps of:
receiving third address data in a third format;
testing compatibility of the third address data relative to the second format; and
selectively converting, in accordance with an output of the compatibility testing step, address data in the format to address data in the second format.

27. The computer-implemented method for enabling a cross-compatible address book for multiple document processing devices of claim 26, wherein address data in the first format is native to a first document processing device and address data in the third format is native to second document processing device, and wherein the first format and third format are mutually incompatible.

28. The computer-implemented method for enabling a cross-compatible address book for multiple document processing devices of claim 27, wherein the first document processing device is at least one of the group consisting of a copy machine, a printer, a facsimile machine, a scanner, and a multifunction peripheral device, and wherein the second document processing device is at least one of the group consisting of a copy machine, a printer, a facsimile machine, a scanner, and a multifunction peripheral device.
